(19) United States
(12) Patent Application Publication
(10) Pub. No.: US 2011/0227920 A1
(43) Pub. Date: Sep. 22, 2011

(54) Method and System For a Shader Processor With Closely-Coupled Peripherals

(76) Inventors: James Adams, Cambridge (GB); Gary Keall, Long Clawson (GB); Eben Upton, Cambridge (GB); Giles Edkins, Cambridge (GB)

(21) Appl. No.: 12/869,900

(22) Filed: Aug. 27, 2010

Related U.S. Application Data
(60) Provisional application No. 61/315,620, filed on Mar. 19, 2010.

(51) Int. Cl. G06T 15/50

(52) U.S. Cl. 345/426

(57) ABSTRACT

A method and system are provided in which a first instruction associated with a graphics rendering operation may be executed in a shader processor, the shader processor may receive result information associated with an intermediate portion of the graphics rendering operation performed by a peripheral device operably coupled to a register file bus in the shader processor, and the shader processor may execute a second instruction associated with the graphics rendering operation based on the received result information. The register file bus may be utilized for handling execution of intermediate instructions associated with the intermediate portion of the graphics rendering operation. The peripheral device may be accessed via one or more register file addresses associated with the peripheral device. The peripheral device may be operably coupled to the shader processor via a FIFO.

### CROSS-REFERENCE TO RELATED APPLICATIONS/INCORPORATION BY REFERENCE

This application makes reference to, claims priority to, and claims the benefit of U.S. Provisional Application Ser. No. 61/315,620, filed Mar. 19, 2010.

This application also makes reference to:
U.S. Patent Application Ser. No. 61/318,653 (Attorney Docket Number 21160US01) which was filed on Mar. 29, 2010;
U.S. Patent Application Ser. No. 61/287,269 (Attorney Docket Number 21161 US01) which was filed on Dec. 17, 2009;
U.S. Patent Application Ser. No. 61/311,640 (Attorney Docket Number 21162US01) which was filed on Mar. 8, 2010;
U.S. Patent Application Ser. No. 61/315,599 (Attorney Docket Number 21163US01) which was filed on Mar. 19, 2010;
U.S. Patent Application Ser. No. 61/328,541 (Attorney Docket Number 21164US01) which was filed on Apr. 27, 2010;
U.S. Patent Application Ser. No. 61/312,988 (Attorney Docket Number 21166US01) which was filed on Mar. 11, 2010;
U.S. Patent Application Ser. No. 61/321,244 (Attorney Docket Number 21172US01) which was filed on Apr. 6, 2010;
U.S. Patent Application Ser. No. 61/315,637 (Attorney Docket Number 21177US01) which was filed on Mar. 19, 2010; and
U.S. Patent Application Ser. No. 61/326,849 (Attorney Docket Number 21178US01) which was filed on Apr. 22, 2010.

Each of the above stated applications is hereby incorporated herein by reference in its entirety.

### FIELD OF THE INVENTION

Certain embodiments of the invention relate to communication systems. More specifically, certain embodiments of the invention relate to a shader processor with closely-coupled peripherals.

### BACKGROUND OF THE INVENTION

Image and video capabilities may be incorporated into a wide range of devices such as, for example, cellular phones, personal digital assistants, digital televisions, digital direct broadcast systems, digital recording devices, gaming consoles and the like. Operating on video data, however, may be very computationally intensive because of the large amounts of data that need to be constantly moved around. This normally requires systems with powerful processors, hardware accelerators, and/or substantial memory, particularly when video encoding is required. Such systems may typically use large amounts of power, which may make them less than suitable for certain applications, such as mobile applications.

Due to the ever growing demand for image and video capabilities, there is a need for power-efficient, high-performance multimedia processors that may be used in a wide range of applications, including mobile applications. Such multimedia processors may support multiple operations including audio processing, image sensor processing, video recording, media playback, graphics, three-dimensional (3D) gaming, and/or other similar operations.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for a shader processor with closely-coupled peripherals, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary multimedia system that is operable to provide a shader processor with closely-coupled peripherals, in accordance with an embodiment of the invention.

FIG. 1B is a block diagram of an exemplary multimedia processor that is operable to provide a shader processor with closely-coupled peripherals, in accordance with an embodiment of the invention.

FIG. 2 is a block diagram that illustrates an exemplary video processing core architecture that is operable to provide a shader processor with closely coupled peripherals, in accordance with an embodiment of the invention.

FIG. 3 is a block diagram that illustrates an exemplary 3D pipeline comprising a shader processor with closely-coupled peripherals, in accordance with an embodiment of the invention.

FIG. 4 is a block diagram that illustrates a shader processor architecture, in accordance with an embodiment of the invention.

FIG. 5 is a block diagram that illustrates a typical connection between a central processing unit (CPU) and devices external to the CPU, in connection with an embodiment of the invention.

FIG. 6 is a block diagram that illustrates a peripheral device operably coupled to a shader processor via a register file bus, in accordance with an embodiment of the invention.

FIG. 7 is a block diagram that illustrates shader processor pipelines and a peripheral pipeline, in accordance with an embodiment of the invention.

FIG. 8 is a block diagram that illustrates different peripheral devices operably coupled to a shader processor via a register file bus, in accordance with an embodiment of the invention.

FIG. 9 is a flow diagram that illustrates exemplary steps for performing an operation in a peripheral device operably coupled to a shader processor, in accordance with an embodiment of the invention.

FIG. 10 is a block diagram that illustrates an example of operably coupling a shader processor and a peripheral device utilizing a FIFO, in accordance with an embodiment of the invention.

### DETAILED DESCRIPTION OF THE INVENTION

Certain embodiments of the invention can be found in a method and system for a shader processor with closely-coupled peripherals. In accordance with various embodiments of the invention, a shader processor may be operable to execute a first instruction associated with a graphics rendering operation, the shader processor may receive result information associated with an intermediate portion of the graphics rendering operation performed by a peripheral device operably coupled to a register file bus in the shader processor, and the shader processor may execute a second instruction associated with the graphics rendering operation based on the received result information. The register file bus may be utilized for handling execution of intermediate instructions associated with the intermediate portion of the graphics rendering operation.

The peripheral device may be accessed via one or more register file addresses associated with the peripheral device. The operation performed in the peripheral device may comprise an operation based on a base-2 logarithm. The operation performed in the peripheral device may comprise a variable latency operation. The peripheral device may be operably coupled to the shader processor via a FIFO comprising an input associated with a register file address in the processor. The peripheral device may be operably coupled to the shader processor via a FIFO comprising an output associated with to one or more register file addresses in the processor. One or more intermediate instructions may be executed in the shader processor between the first instruction and the second instruction that are independent from the result information associated with the intermediate portion of the graphics rendering operation. The shader processor may comprise a fixed-cycle-pipeline architecture. An example of such fixed-cycle pipeline architecture is a 3-stage floating-point execute pipeline that may be operated without stalls and/or interlocks. In this regard, the stalls may be localized in a register-fetch stage at the start of the pipeline. The shader processor may comprise a single-instruction-multiple-data (SIMD) architecture. The peripheral device may comprise one or more of a texture unit, a varying interpolator, a color tile memory, a depth tile memory, a vertex memory, and a primitive memory. The instructions and/or operations may be associated with a graphics rendering operation.

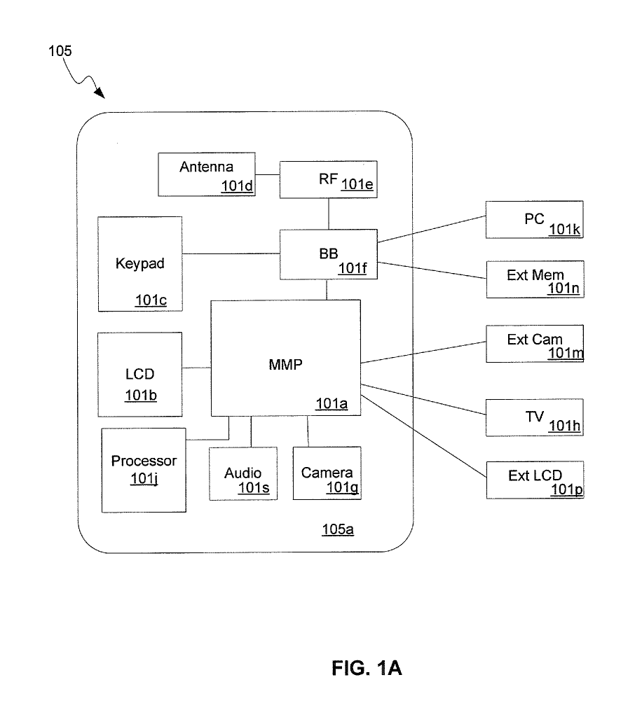

FIG. 1A is a block diagram of an exemplary multimedia system that is operable to provide a shader processor with closely-coupled peripherals, in accordance with an embodiment of the invention. Referring to FIG. 1A, there is shown a mobile multimedia system 105 that comprises a mobile multimedia device 105a, a television (TV) 101h, a personal computer (PC) 101k, an external camera 101m, external memory 101n, and external liquid crystal display (LCD) 101p. The mobile multimedia device 105a may be a cellular telephone or other handheld communication device. The mobile multimedia device 105a may comprise a mobile multimedia processor (MMP) 101a, an antenna 101d, an audio block 101s, a radio frequency (RF) block 101e, a baseband processing block 101f, an LCD 101b, a keypad 101c, and a camera 101g.

The MMP 101a may comprise suitable circuitry, logic, interfaces, and/or code that may be operable to perform video and/or multimedia processing for the mobile multimedia device 105a. The MMP 101a may also comprise integrated interfaces, which may be utilized to support one or more external devices coupled to the mobile multimedia device 105a. For example, the MMP 101a may support connections to a TV 101h, an external camera 101m, and an external LCD 101p.

The processor 101j may comprise suitable circuitry, logic, interfaces, and/or code that may be operable to control processes in the mobile multimedia system 105. Although not shown in FIG. 1A, the processor 101j may be coupled to a plurality of devices in and/or coupled to the mobile multimedia system 105.

In operation, the mobile multimedia device may receive signals via the antenna 101d. Received signals may be processed by the RF block 101e and the RF signals may be converted to baseband by the baseband processing block 101f. Baseband signals may then be processed by the MMP 101a. Audio and/or video data may be received from the external camera 101m, and image data may be received via the integrated camera 101g. During processing, the MMP 101a may utilize the external memory 101n for storing of processed data. Processed audio data may be communicated to the audio block 101s and processed video data may be communicated to the LCD 101b and/or the external LCD 101p, for example. The keypad 101c may be utilized for communicating processing commands and/or other data, which may be required for audio or video data processing by the MMP 101a.

In an embodiment of the invention, the MMP 101A may be operable to perform three-dimensional (3D) pipeline processing of video signals. More particularly, the MMP 101A may be operable to perform shading operations with one or more shader processors, where the one or more shader processors may operate with closely-coupled peripherals. The MMP 101a may process video signals within a plurality of video modules, as described further with respect to FIG. 1B.

FIG. 1B is a block diagram of an exemplary multimedia processor that is operable to provide a shader processor with closely-coupled peripherals, in accordance with an embodiment of the invention. Referring to FIG. 1B, the mobile multimedia processor 102 may comprise suitable logic, circuitry, interfaces, and/or code that may be operable to perform video and/or multimedia processing for handheld multimedia products. For example, the mobile multimedia processor 102 may be designed and optimized for video record/playback, mobile TV and 3D mobile gaming, utilizing integrated peripherals and a video processing core. The mobile multimedia processor 102 may comprise a video processing core 103 that may comprise a video processing unit (VPU) 103A, a graphic processing unit (GPU) 103B, an image sensor pipeline (ISP) 103C, a 3D pipeline 103D, a direct memory access (DMA) controller 163, a Joint Photographic Experts Group (JPEG) encoding/decoding module 103E, and a video encoding/decoding module 103F. The mobile multimedia processor 102 may also comprise on-chip RAM 104, an analog block 106, a phase-locked loop (PLL) 109, an audio interface (I/F) 142, a memory stick I/F 144, a Secure Digital input/output (SDIO) I/F 146, a Joint Test Action Group (JTAG) I/F 148, a TV output I/F 150, a Universal Serial Bus (USB) I/F 152, a camera I/F 154, and a host I/F 129. The mobile multimedia processor 102 may further comprise a serial peripheral interface (SPI) 157, a universal asynchronous receiver/transmitter (UART) I/F 159, a general purpose input/output (GPIO) pins 164, a display controller 162, an external memory I/F 158, and a second external memory I/F 160.

The video processing core 103 may comprise suitable logic, circuitry, interfaces, and/or code that may be operable to perform video processing of data. The on-chip Random Access Memory (RAM) 104 and the Synchronous Dynamic RAM (SDRAM) 140 comprise suitable logic, circuitry and/or code that may be adapted to store data such as image or video data.

The image sensor pipeline (ISP) 103C may comprise suitable circuitry, logic and/or code that may be operable to process image data. The ISP 103C may perform a plurality of processing techniques comprising filtering, demosaic, lens shading correction, defective pixel correction, white balance, image compensation, Bayer interpolation, color transformation, and post filtering, for example. The processing of image data may be performed on variable sized tiles, reducing the memory requirements of the ISP 103C processes.

The GPU 103B may comprise suitable logic, circuitry, interfaces, and/or code that may be operable to offload graphics rendering from a general processor, such as the processor 101j, described with respect to FIG. 1A. The GPU 103B may be operable to perform mathematical operations specific to graphics processing, such as texture mapping and rendering polygons, for example.

The 3D pipeline 103D may comprise suitable circuitry, logic and/or code that may enable the rendering of 2D and 3D graphics. The 3D pipeline 103D may perform a plurality of processing techniques comprising vertex processing, rasterizing, early-Z culling, interpolation, texture lookups, pixel shading, depth test, stencil operations and color blend, for example. The 3D pipeline 103D may comprise one or more shader processors that may be operable to perform rendering operations. The shader processors may be closely-coupled with peripheral devices to perform such rendering operations.

The JPEG module 103E may comprise suitable logic, circuitry, interfaces, and/or code that may be operable to encode and/or decode JPEG images. JPEG processing may enable compressed storage of images without significant reduction in quality.

The video encoding/decoding module 103F may comprise suitable logic, circuitry, interfaces, and/or code that may be operable to encode and/or decode images, such as generating full 108 p HD video from H.264 compressed data, for example. In addition, the video encoding/decoding module 103F may be operable to generate standard definition (SD) output signals, such as phase alternating line (PAL) and/or national television system committee (NTSC) formats.

Also shown in FIG. 1B are an audio block 108 that may be coupled to the audio interface I/F 142, a memory stick 110 that may be coupled to the memory stick I/F 144, an SD card block 112 that may be coupled to the SDIO IF 146, and a debug block 114 that may be coupled to the JTAG I/F 148. The PAL/NTSC/high definition multimedia interface (HDMI) TV output I/F 150 may be utilized for communication with a TV, and the USB 1.1, or other variant thereof, slave port I/F 152 may be utilized for communications with a PC, for example. A crystal oscillator (XTAL) 107 may be coupled to the PLL 109. Moreover, cameras 120 and/or 122 may be coupled to the camera I/F 154.

Also shown in FIG. 1B are a baseband processing block 126 that may be coupled to the host interface 129, a radio frequency (RF) processing block 130 coupled to the baseband processing block 126 and an antenna 132, a basedband flash 124 that may be coupled to the host interface 129, and a keypad 128 coupled to the baseband processing block 126. A main LCD 134 may be coupled to the mobile multimedia processor 102 via the display controller 162 and/or via the second external memory interface 160, for example, and a subsidiary LCD 136 may also be coupled to the mobile multimedia processor 102 via the second external memory interface 160, for example. Moreover, an optional flash memory 138 and/or an SDRAM 140 may be coupled to the external memory I/F 158.

In operation, the mobile multimedia processor 102 may be adapted to perform tile mode rendering in two separate phases. A first phase may comprise a binning process or operation and a second phase may comprise a rendering process or operation. During the first or binning phase, it may be determined which pixel tiles in a screen plane are covered or overlapped by each graphic primitive associated with a video frame, for example. During this phase, an ordered list of primitives and/or state-change data for each tile may be built. A coordinate shader may be utilized to perform at least some of the operations associated with the binning phase. The list or lists generated during the binning phase may comprise indices (e.g., vertex indices) that make reference to a table that comprises attributes of the vertices of the primitives. In some embodiments of the invention, the indices in the list or lists may be compressed. During the second or rendering phase, the contents associated with each pixel tile may be drawn or rendered. The rendering phase may utilize the list or lists generated during the binning phase that provide a reference to the vertex attributes of the primitives located within the tile. The vertex attributes may be brought into local memory on a tile-by-tile basis, for example. A vertex shader may be utilized to perform at least some of the operations of the rendering phase. Once a pixel tile is rendered, the rendered pixels may be pushed to main memory, for example, and a similar approach may be followed with other pixel tiles.

The coordinate shader and the vertex shader may each be implemented using one or more shader processors. In some embodiments of the invention, the coordinate shading operations performed by a coordinate shader and the vertex shading operations performed by a vertex shader may be implemented using one or more common shader processors. The shader processors may be operable with closely-coupled peripherals to perform instructions and/or operations associated with the coordinate and/or vertex shading operations.

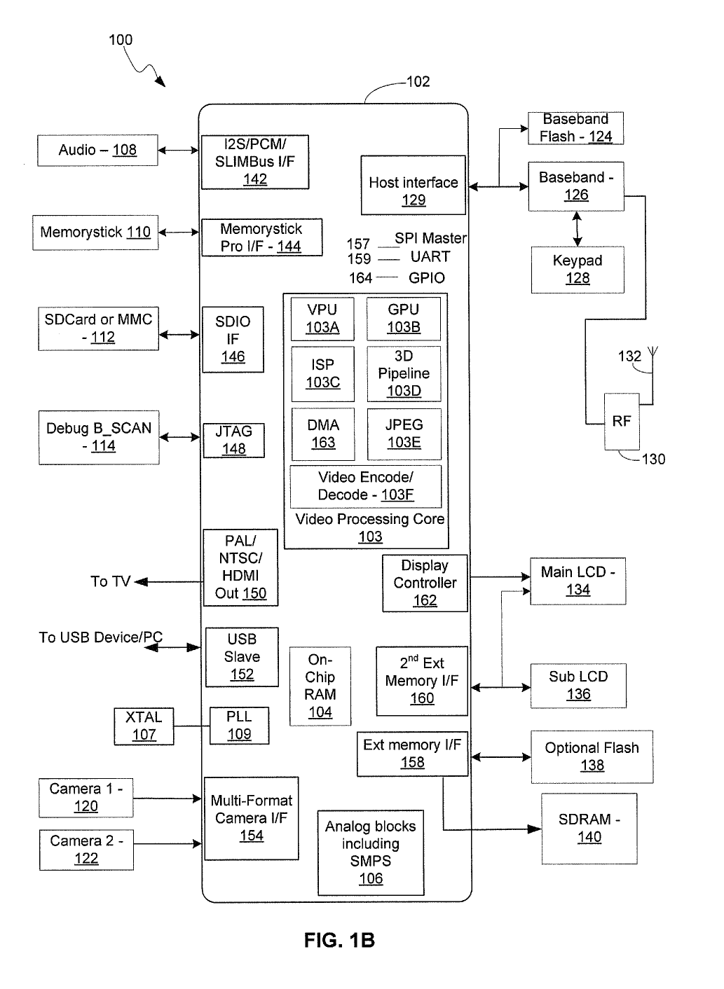

FIG. 2 is a block diagram that illustrates an exemplary video processing core architecture that is operable to provide a shader processor with closely coupled peripherals, in accordance with an embodiment of the invention. Referring to FIG. 2, there is shown a video processing core 200 comprising suitable logic, circuitry, interfaces and/or code that may be operable for high performance video and multimedia processing. The architecture of the video processing core 200 may provide a flexible, low power, and high performance multimedia solution for a wide range of applications, including mobile applications, for example. By using dedicated hardware pipelines in the architecture of the video processing core 200, such low power consumption and high performance goals may be achieved. The video processing core 200 may correspond to, for example, the video processing core 103 described above with respect to FIG. 1B.

The video processing core 200 may support multiple capabilities, including image sensor processing, high rate (e.g., 30 frames-per-second) high definition (e.g., 1080 p) video encoding and decoding, 3D graphics, high speed JPEG encode and decode, audio codecs, image scaling, and/or LCD an TV outputs, for example.

In one embodiment, the video processing core 200 may comprise an Advanced eXtensible Interface/Advanced Peripheral (AXI/APB) bus 202, a level 2 cache 204, a secure boot 206, a Vector Processing Unit (VPU) 208, a DMA controller 210, a JPEG encoder/decoder (endec) 212, a systems peripherals 214, a message passing host interface 220, a Compact Camera Port 2 (CCP2) transmitter (TX) 222, a Low-Power Double-Data-Rate 2 SDRAM (LPDDR2 SDRAM) controller 224, a display driver and video scaler 226, and a display transposer 228. The video processing core 200 may also comprise an ISP 230, a hardware video accelerator 216, a 3D pipeline 218, and peripherals and interfaces 232. In other embodiments of the video processing core 200, however, fewer or more components than those described above may be included.

In one embodiment, the VPU 208, the ISP 230, the 3D pipeline 218, the JPEG endec 212, the DMA controller 210, and/or the hardware video accelerator 216, may correspond to the VPU 103A, the ISP 103C, the 3D pipeline 103D, the JPEG 103E, the DMA 163, and/or the video encode/decode 103F, respectively, described above with respect to FIG. 1B.

Operably coupled to the video processing core 200 may be a host device 280, an LPDDR2 interface 290, and/or LCD/TV displays 295. The host device 280 may comprise a processor, such as a microprocessor or Central Processing Unit (CPU), microcontroller, Digital Signal Processor (DSP), or other like processor, for example. In some embodiments, the host device 280 may correspond to the processor 101j described above with respect to FIG. 1A. The LPDDR2 interface 290 may comprise suitable logic, circuitry, and/or code that may be operable to allow communication between the LPDDR2 SDRAM controller 224 and memory. The LCD/TV displays 295 may comprise one or more displays (e.g., panels, monitors, screens, cathode-ray tubes (CRTs)) for displaying image and/or video information. In some embodiments, the LCD/TV displays 295 may correspond to one or more of the TV 101h and the external LCD 101p described above with respect to FIG. 1A, and the main LCD 134 and the sub LCD 136 described above with respect to FIG. 1B.

The message passing host interface 220 and the CCP2 TX 222 may comprise suitable logic, circuitry, and/or code that may be operable to allow data and/or instructions to be communicated between the host device 280 and one or more components in the video processing core 200. The data communicated may include image and/or video data, for example.

The LPDDR2 SDRAM controller 224 and the DMA controller 210 may comprise suitable logic, circuitry, and/or code that may be operable to control the access of memory by one or more components and/or processing blocks in the video processing core 200.

The VPU 208 may comprise suitable logic, circuitry, and/or code that may be operable for data processing while maintaining high throughput and low power consumption. The VPU 208 may allow flexibility in the video processing core 200 such that software routines, for example, may be inserted into the processing pipeline. The VPU 208 may comprise dual scalar cores and a vector core, for example. The dual scalar cores may use a Reduced Instruction Set Computer (RISC)-style scalar instruction set and the vector core may use a vector instruction set, for example. Scalar and vector instructions may be executed in parallel.

Although not shown in FIG. 2, the VPU 208 may comprise one or more Arithmetic Logic Units (ALUs), a scalar data bus, a scalar register file, one or more Pixel-Processing Units (PPUs) for vector operations, a vector data bus, a vector register file, a Scalar Result Unit (SRU) that may operate on one or more PPU outputs to generate a value that may be provided to a scalar core. Moreover, the VPU 208 may comprise its own independent level 1 instruction and data cache.

The ISP 230 may comprise suitable logic, circuitry, and/or code that may be operable to provide hardware accelerated processing of data received from an image sensor (e.g., charge-coupled device (CCD) sensor, complimentary metal-oxide semiconductor (CMOS) sensor). The ISP 230 may comprise multiple sensor processing stages in hardware, including demosaicing, geometric distortion correction, color conversion, denoising, and/or sharpening, for example. The ISP 230 may comprise a programmable pipeline structure. Because of the close operation that may occur between the VPU 208 and the ISP 230, software algorithms may be inserted into the pipeline.

The hardware video accelerator 216 may comprise suitable logic, circuitry, and/or code that may be operable for hardware accelerated processing of video data in any one of multiple video formats such as H.264, Windows Media 8/9/10 (VC-1), MPEG-1, MPEG-2, and MPEG-4, for example. For H.264, for example, the hardware video accelerator 216 may encode at full HD 1080 p at 30 frames-per-second (fps). For MPEG-4, for example, the hardware video acceleration 216 may encode a HD 720 p at 30 fps. For H.264, VC-1, MPEG-1, MPEG-2, and MPEG-4, for example, the hardware video accelerator 216 may decode at full HD 1080 p at 30 fps or better. The hardware video accelerator 216 may be operable to provide concurrent encoding and decoding for video conferencing and/or to provide concurrent decoding of two video streams for picture-in-picture applications, for example.

The 3D pipeline 218 may comprise suitable logic, circuitry, and/or code that may be operable to provide 3D rendering operations for use in, for example, graphics applications. The 3D pipeline 218 may support OpenGL-ES 2.0, OpenGL-ES 1.1, and OpenVG 1.1, for example. The 3D pipeline 218 may comprise a multi-core programmable pixel shader, for example. The 3D pipeline 218 may be operable to handle 32M triangles-per-second (16M rendered triangles-per-second), for example. The 3D pipeline 218 may be operable to handle 1 G rendered pixels-per-second with Gouraud shading and one bi-linear filtered texture, for example. The 3D pipeline 218 may support four times (4×) full-screen anti-aliasing at full pixel rate, for example.

The 3D pipeline 218 may comprise a tile mode architecture in which a rendering operation may be separated into a first phase and a second phase. During the first phase, the 3D pipeline 218 may utilize a coordinate shader to perform a binning operation. The coordinate shader may be obtained from a vertex shader at compile time, for example. In one embodiment of the invention, the coordinate shader may be obtained automatically during vertex shader compilation. The coordinate shader may comprise those portions of the vertex shader that relate to the processing of the coordinates of the vertices. Such coordinates may be utilized to, for example, control the binning operation and need not be stored for subsequent use such as during the second phase, for example.

During the second phase, the 3D pipeline 218 may utilize a vertex shader to render images such as those in frames in a video sequence, for example. A vertex shader may typically be utilized to transform a 3D position of a vertex from a graphics primitive such as triangles or polygons, for example, in a virtual space to a corresponding two-dimensional (2D) coordinate at on a screen plane. A vertex shader may also be utilized to obtain a depth value for a Z-buffer for a vertex. A vertex shader may process various vertex properties such as color, position, and/or texture coordinates. The output of a vertex shader may be utilized by a geometry shader and/or a rasterizer, for example. Because the coordinate shader utilized in the first phase need not generate a complete set of vertex properties that can be produced by a typical full vertex shader, those values need not be stored for later use, which may result in reduced memory and/or bandwidth requirements.

The 3D pipeline 218 may comprise one or more shader processors that may be operable to perform rendering operations. The shader processors may be closely-coupled with peripheral devices to perform instructions and/or operations associated with such rendering operations.

The JPEG endec 212 may comprise suitable logic, circuitry, and/or code that may be operable to provide processing (e.g., encoding, decoding) of images. The encoding and decoding operations need not operate at the same rate. For example, the encoding may operate at 120M pixels-per-second and the decoding may operate at 50M pixels-per-second depending on the image compression.

The display driver and video scaler 226 may comprise suitable logic, circuitry, and/or code that may be operable to drive the TV and/or LCD displays in the TV/LCD displays 295. In this regard, the display driver and video scaler 226 may output to the TV and LCD displays concurrently and in real time, for example. Moreover, the display driver and video scaler 226 may comprise suitable logic, circuitry, and/or code that may be operable to scale, transform, and/or compose multiple images. The display driver and video scaler 226 may support displays of up to full HD 1080 p at 60 fps.

The display transposer 228 may comprise suitable logic, circuitry, and/or code that may be operable for transposing output frames from the display driver and video scaler 226. The display transposer 228 may be operable to convert video to 3D texture format and/or to write back to memory to allow processed images to be stored and saved.

The secure boot 206 may comprise suitable logic, circuitry, and/or code that may be operable to provide security and Digital Rights Management (DRM) support. The secure boot 206 may comprise a boot Read Only Memory (ROM) that may be used to provide secure root of trust. The secure boot 206 may comprise a secure random or pseudo-random number generator and/or secure (One-Time Password) OTP key or other secure key storage.

The AXI/APB bus 202 may comprise suitable logic, circuitry, and/or interface that may be operable to provide data and/or signal transfer between various components of the video processing core 200. In the example shown in FIG. 2, the AXI/APB bus 202 may be operable to provide communication between two or more of the components the video processing core 200.

The AXI/APB bus 202 may comprise one or more buses. For example, the AXI/APB bus 202 may comprise one or more AXI-based buses and/or one or more APB-based buses. The AXI-based buses may be operable for cached and/or uncached transfer, and/or for fast peripheral transfer. The APB-based buses may be operable for slow peripheral transfer, for example. The transfer associated with the AXI/APB bus 202 may be of data and/or instructions, for example.

The AXI/APB bus 202 may provide a high performance system interconnection that allows the VPU 208 and other components of the video processing core 200 to communicate efficiently with each other and with external memory.

The level 2 cache 204 may comprise suitable logic, circuitry, and/or code that may be operable to provide caching operations in the video processing core 200. The level 2 cache 204 may be operable to support caching operations for one or more of the components of the video processing core 200. The level 2 cache 204 may complement level 1 cache and/or local memories in any one of the components of the video processing core 200. For example, when the VPU 208 comprises its own level 1 cache, the level 2 cache 204 may be used as complement. The level 2 cache 204 may comprise one or more blocks of memory. In one embodiment, the level 2 cache 204 may be a 128 kilobyte four-way set associate cache comprising four blocks of memory (e.g., Static RAM (SRAM)) of 32 kilobytes each.

The system peripherals 214 may comprise suitable logic, circuitry, and/or code that may be operable to support applications such as, for example, audio, image, and/or video applications. In one embodiment, the system peripherals 214 may be operable to generate a random or pseudo-random number, for example. The capabilities and/or operations provided by the peripherals and interfaces 232 may be device or application specific.

In operation, the video processing core 200 may be operable to carry out multiple multimedia tasks simultaneously without degrading individual function performance. In various exemplary embodiments of the invention, the 3D pipeline 218 may be operable to provide 3D rendering, such as tile-based rendering, for example, that may comprise a first or binning phase and a second or rendering phase. In this regard, the 3D pipeline 218 and/or other components of the video processing core 200 that are used to provide 3D rendering operations may be referred to as a tile-mode renderer. The 3D pipeline 218 may comprise one or more shader processors that may be operable with closely-coupled peripheral devices to perform instructions and/or operations associated with such rendering operations.

The video processing core 200 may also be operable to implement movie playback operations. In this regard, the video processing core 200 may be operable to add 3D effects to video output, for example, to map the video onto 3D surfaces or to mix 3D animation with the video. In another exemplary embodiment of the invention, the video processing core 200 may be utilized in a gaming device. In this regard, full 3D functionality may be utilized. The VPU 208 may be operable to execute a game engine and may supply graphics primitives (e.g., polygons) to the 3D pipeline 218 to enable high quality self-hosted games. In another embodiment, the video processing core 200 may be utilized for stills capture. In this regard, the ISP 230 and/or the JPEG endec 212 may be utilized to capture and encode a still image. For stills viewing and/or editing, the JPEG endec 212 may be utilized to decode the stills data and the video scaler may be utilized for display formatting. Moreover, the 3D pipeline 218 may be utilized for 3D effects, for example, for warping an image or for page turning transitions in a slide show, for example.

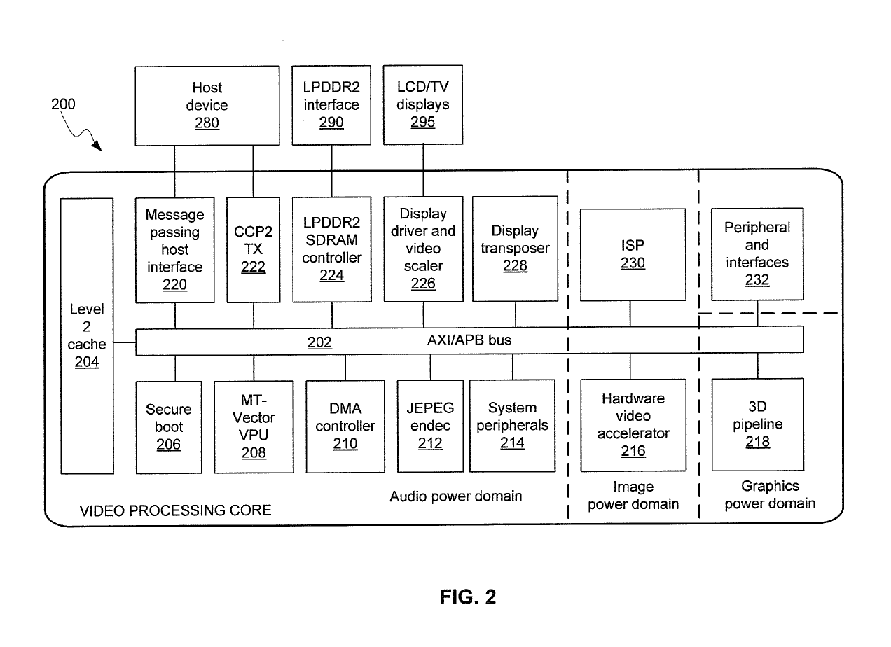

FIG. 3 is a block diagram that illustrates an exemplary 3D pipeline comprising a shader processor with closely-coupled peripherals, in accordance with an embodiment of the invention. Referring to FIG. 3, there is shown a 3D pipeline 300 that may comprise a control processor (CP) 302, a vertex cache manager and DMA (VCM and VCD) 304, a primitive tile binner (PTB) 306, a primitive setup engine (PSE) 308, a front-end pipe (FEP) 310, a coverage accumulate pipe (CAP) 312, a quad processor (QPU) scheduler 314, a vertex and primitive memory (VPM) 316, a tile buffer (TLB) 318, a bus arbiter (AIX ARB) 320, a cache 330, an interpolator (QVI) 340, a coefficients memory 342, a uniforms cache (QUC) 344, an instruction cache (QIC) 346, a texture and memory lookup unit (TMU) 348 and a plurality of QPUs 350, 352, 354, and 356. In the embodiment of the invention illustrated in FIG. 3, there may be a plurality of groups or slices in the 3D pipeline 300, where each slice may comprise plurality of QPUs. For example, the 3D pipeline 300 may comprise slices 0, 1, 2, and 3, each slice comprising four QPUs.

The 3D pipeline 300 may be similar and/or substantially the same as the 3D pipeline 218 described with respect to FIG. 2 and/or may be implemented within the mobile multimedia system 105 described above with respect to FIG. 1A, for example. The 3D pipeline 300 may comprise a scalable architecture and may comprise a plurality of floating-point shading processors such as, for example, the QPUs 350, 352, 354, and 356. In various embodiments of the invention, the 3D pipeline 300 may be operable to support OpenGL-ES and/or OpenVG applications. Moreover, the 3D pipeline 300 may be utilized in a wide variety of system-on-chip (SoC) devices. The 3D pipeline 300 may comprise suitable logic, circuitry, interfaces and/or code that may be operable to perform tile-based pixel rendering. Tile based pixel rendering may enable improvements in memory bandwidth and processing performance. In this regard, during graphics processing and/or storage, a frame may be divided into a plurality of areas referred to as pixel tiles or tiles. A pixel tile may correspond to, for example, a 32 pixels×32 pixels area in a screen plane. The 3D pipeline 300 may be operable to provide a first or binning phase and a second or rendering phase of graphics primitives processing utilizing a tile-by-tile approach. The various types of graphics primitives that may be utilized with the 3D pipeline 300 may be referred to generally as primitives.

The QPUs 350, 352, 354 and 356 may comprise suitable logic, circuitry, interfaces and/or code that may be operable to perform tile-based rendering operations. The rendering operations may comprise a binning phase in which a coordinate shader is utilized and a rendering phase in which a vertex shader is utilized. A QPU may comprise a special purpose floating-point shader processor. The shader processor may be operably coupled to one or more peripheral devices comprised within the 3D pipeline 300. In this regard, one or more components in the 3D pipeline 300 may be utilized as peripheral devices that are closely coupled to the shader processor. Moreover, when the 3D pipeline 300 is used in a device such as the video processing core 200, which is described above with respect to FIG. 2, the shader processor may be operably coupled to one or more peripheral devices comprised within the video processing core 200. In one embodiment, a QPU may comprise a fixed-cycle pipeline structure, such as a 3-cycle-pipeline structure, for example. In various embodiments of the invention, each of QPUs 350, 352, 356 and/or 356 may comprise a 16-way single instruction multiple data (SIMD) processor that may be operable to process streams of pixels, however, the invention need not be limited in this regard. As described above, the QPUs may be organized into groups of 4, for example, that may be referred to as slices. The QPUs 350, 352, 356 and/or 356 may share various common resources. For example, the slices may share the QIC 346, one or two TMUs 348, the QUC 344, the coefficients memory 342 and/or the QVI 340. The QPUs 350, 352, 354 and 356 may be closely coupled to 3D hardware for fragment shading and utilize signaling instructions and dedicated internal registers. The QPUs 350, 352, 354 and 356 may also support a plurality of hardware threads with cooperative thread switching that may hide texture lookup latency during 3D fragment shading.

The QPUs 350, 352, 354 and/or 356 may be operable to perform various aspects of interpolating vertices in modified primitives, for example, in clipped primitives. The interpolated vertices may be referred to as varyings. In this regard, blend functions and/or various aspects of the varyings interpolation may be performed in software.

In some embodiments of the invention, the 3D pipeline may be simplified by decoupling memory access operations and certain instructions, such as reciprocal, reciprocal square root, logarithm, and exponential, for example, and placing them in asynchronous I/O peripherals operably coupled to a QPU core by, for example, FIFOs. Moreover, although the QPUs may be within and closely coupled to the 3D system, the QPUs may also be capable of providing a general-purpose computation resource to non-3D operations such as video codecs and/or the image sensor pipeline.

The VCM and VCD 304 may comprise suitable logic, circuitry, interfaces and/or code that may be operable to collect batches of vertex attributes and may place them into the VPM 316. Each batch of vertices may be shaded by one of the QPUs 350, 352, 356 and/or 356 and the results may be stored back into the VPM 316.

During the first phase or binning phase of the rendering operation, the vertex coordinate transform portion of the operation that is typically performed by a vertex shader may be performed by the coordinate shader. The PTB 306 may fetch the transformed vertex coordinates and primitives from the VPM 316 and may determine which pixel tiles, if any, the primitive overlaps. The PTB 306 may build a list in memory for each tile, for example, which may comprise the primitives that impact that tile and references to any state changes that may apply.

The PSE 308 may comprise suitable logic, circuitry, interfaces and/or code that may be operable to fetch shaded vertex data and primitives from the VPM 316. Moreover, the PSE 308 may be operable to calculate setup data for rasterizing primitives and coefficients of various equations for interpolating the varyings. In this regard, rasteriser setup parameters and Z and W interpolation coefficients may be fed to the FEP 310. The varyings interpolation coefficients may be stored directly to a memory within a slice for just-in-time interpolation.

The FEP 310 may comprise suitable logic, circuitry, interfaces and/or code that may be operable to perform rasteriser, Z interpolation, Early-Z test, W interpolation and W reciprocal functions. Groups of pixels output by the FEP 310 may be stored into registers mapped into QPUs which may be scheduled to carry out fragment shading for that group of pixels.

There may be a TMU 348 per slice, but texturing performance may be scaled by providing additional TMUs. Because of the use of multiple slices, the same texture may appear in more than one TMU 348. To avoid memory bandwidth and waste of cache memory with common textures, there may be a L2 texture cache (TL2), and each TMU 348 may comprise a small internal cache.

The TMUs 348 may comprise suitable logic, circuitry, interfaces and/or code that may be operable to perform general purpose data lookups from memory and/or for filtered texture lookups. Alternatively, the VCM and VCD 304 may be operable to perform direct memory access of data going into or out of the VPM 316 where it may be accessed by the QPUs. The QPUs may also read program constants, such as non-index shader uniforms, as a stream of data from main memory via the QUC 344.

The CAP 312 may comprise suitable logic, circuitry, interfaces and/or code that may be operable to perform OpenVG coverage rendering, for example. In this regard, the QPUs may be bypassed.

The QPUs and/or the CAP 312 may output pixel data to the TLB 318. In various embodiments of the invention, the TLB 318 may be configured to handle 64×64 samples and/or may support 32×32 pixel tiles. In other embodiments of the invention, TLB 318 may handle 64×64 pixel tiles in non-multi-sample and/or OpenVG 16× coverage modes. The TLB may also be configured to handle 64×32 samples with 64-bit floating-point color for HDR rendering. The TLB 318 may be operable to write decimated color data to a main memory frame buffer when rendering of a tile is complete. The TLB 318 may store and/or reload the tile data to and/or from memory using data compression.

In operation, the 3D pipeline 300 may be driven by control lists in memory, which may specify sequences of primitives and system state data. The control processor (CP) 302 may be operable to interpret the control lists and may feed the 3D pipeline 300 with primitive and state data. In various embodiments of the invention, a pixel rendering pass of all tiles may be performed without use of a driver.

The 3D pipeline 300 may perform tile-based pixel rendering in a plurality of phases, for example, a binning phase and a rendering phase. During the first or binning phase of the rendering operation, the vertex coordinate transform portion of the operation that is typically performed by a vertex shader may be performed by a coordinate shader. The PTB 306 may fetch the transformed vertex coordinates and primitives from the VPM 316 and may determine which pixel tiles, if any, the primitive overlaps. The PTB 306 may build a list in memory for each tile, for example, which may comprise the primitives that impact that tile and references to any state changes that may apply.

The 3D pipeline 300 may be operable to clip primitives, for example, triangles or polygons that may extend beyond a tile, viewport, or screen plane. Clipped primitives may be divided into a plurality of new triangles and vertices for the new triangles, which may be referred to as varyings, and may be interpolated. The PSE 308 may also store varying interpolation coefficients concurrently into memory for each QPU slice, for example. In various embodiments of the invention, dedicated hardware may be utilized to partially interpolate varyings and the remaining portion of the interpolation may be performed in software by, for example, one or more QPUs.

During the second or rendering phase of the rendering operation in which a vertex shader is utilized, the 3D pipeline 300 may utilize the tile lists created during the binning phase to perform tile-based shading of vertices and/or primitives. The 3D pipeline 300 may output rendered pixel information.

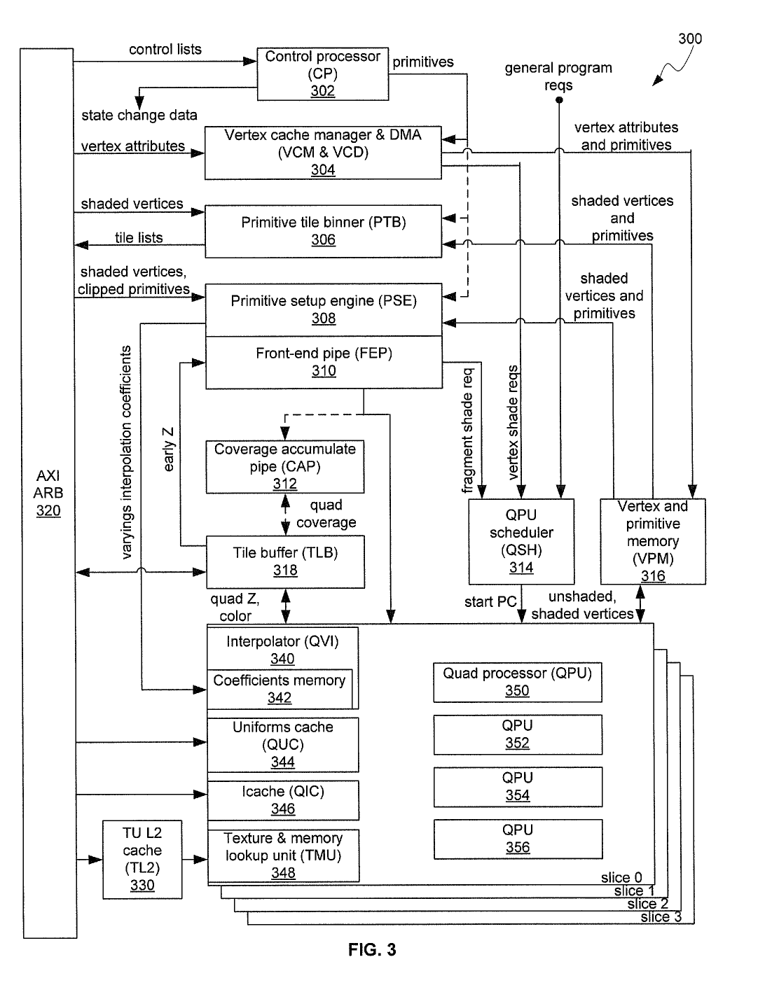

FIG. 4 is a block diagram that illustrates a shader processor architecture, in accordance with an embodiment of the invention. Referring to FIG. 4, there is shown a QPU 400 that may be utilized as a shader processor. The QPU 400 may correspond to, for example, one or more of the QPUs 350, 352, 354, and 356 in the 3D pipeline 300 described above with respect to FIG. 3.

In one embodiment of the invention, the QPU 400 may correspond to a 16-way 32-bit SIMD with asymmetric arithmetic logic units (ALUs). The instructions in the QPU 400 may be executed in a single instruction cycle, for example, such that a result may be written to an accumulator in one instruction and may be available as an input argument in the following instruction. Other embodiments of the invention, however, need not be so limited.

The QPU 400 may comprise a block 402, a register-file memory 420 (register-file A) associated with a register-space 421 (register-space A), a register-file memory 430 (register-file B) associated with a register-space 431 (register-space B), unpackers 422 and 432, a rotator 424, multiplexers 426, 436, 465, 472, and 482, a multiply vector ALU 720, an add vector ALU 480, packers 474 and 484, accumulators 460, and a register-file mapped I/O 450.

The register-files A and B may comprise suitable logic, circuitry, and/or interfaces that may be operable to store bits of information. The accumulators 460 may comprise suitable logic, circuitry, and/or interfaces that may be operable to store intermediate arithmetic and/or logic operations. In one embodiment of the invention, the accumulators 460 may comprise five (5) accumulators, which are labeled A0, A1, A2, A3, and A4 in FIG. 4. In other embodiments of the invention, however, the accumulators 460 may comprise more or fewer than five accumulators. The register-files A and B and the accumulators 460 may correspond to two types of physical registers utilized in the QPU 400.

In one embodiment of the invention, the address space associated with each of the two register-files A and B may extend to a total of 64 locations, for example. Of the 64 locations, the first 32 locations may be backed by physical registers, while the remaining 32 locations may be utilized for register-space I/O, for example.

The rotator 424 in the register-space A may comprise suitable logic, circuitry, and/or interfaces that may be utilized for horizontal rotation of vectors. For example, a 16-way vector read from register-file A may be rotated by any one of sixteen possible horizontal rotations. The rotation may be set by a horizontal rotate I/O space register, for example. Such rotation capabilities may provide the QPU 400 with flexibility in image processing operations, for example.

The unpackers 422 and 432 may comprise suitable logic, circuitry, and/or interfaces that may be operable to unpack vectors from the register-files A and B, respectively. The packers 474 and 484 may comprise suitable logic, circuitry, and/or interfaces that may be operable to pack vectors. The multiplexers 426, 436, 465, 472, and 482 may each comprise suitable logic, circuitry, and/or interfaces that may be operable to select a vector output from a plurality of vector inputs. The multiplexer 465 may comprise a plurality of multiplexers that may be utilized to provide arguments to the multiply vector ALU 470 and/or the add vector ALU 480.

In one embodiment of the invention, the multiply vector ALU 470 and the add vector ALU 480 may be independent and asymmetric ALU units, for example. The multiply vector ALU 470 may comprise suitable logic, circuitry, and/or interfaces that may be operable to perform integer and floating point multiply, integer add, and other multiply-type operations. The add vector ALU 480 may comprise suitable logic, circuitry, and/or interfaces that may be operable to perform add-type operations, integer bit manipulations, shifts, and logical operations.

The multiply vector ALU 470 and the add vector ALU 480 may be enabled to perform operations on integer or floating point data, and may internally operate on 32-bit data, for example. In this regard, the QPU 400 may comprise hardware to read 16-bit data and 8-bit data from the register-files A and B, sign extending 16-bit integers, zero extending 8-bit integers, and/or converting 16-bit floats to 32-bits before the data is fed to the multiply vector ALU 470 and the add vector ALU 480, for example. The QPU 400 may comprise similar logic and/or circuitry that may be operable to re-convert a 32-bit output from the multiply vector ALU 470 and the add vector ALU 480 to 16-bits or 8-bits, for example.

The block 402 may comprise suitable logic, circuitry, code, and/or interfaces that may be operable to handle data and/or instructions in the QPU 400. The regfile mapped I/O 450 may comprise suitable logic, circuitry, and/or interfaces that may be operable to provide mapped I/O space that may be utilized in connection with the register-spaces A and B, for example.

In operation, during a single instruction cycle, a single value may be read from and written to each of the single-port register-spaces A and B. Either of the values read from the register-spaces A and B or any of the accumulator values from the accumulators 460 may be selected for either input argument to the multiple vector ALU 470 or to the add vector ALU 480. The result from each ALU may be written to either of the register-spaces A and B. In some embodiments of the invention, the results from both ALUs may not be written to the same register space.

In the example illustrated in FIG. 4, the accumulators A0, A1, A2, A3, and A4 in the accumulators 460 may be mapped into, for example, addresses 32-36 in register-spaces A and B such that the results of either the multiple vector ALU 470 or the add vector ALU 480 may be written to any of the accumulators in the accumulators 460. Similarly, most I/O locations may be mapped into both register-spaces A and B such that there may be no restriction on the combinations of I/O locations that may be read and written in each instruction. In some embodiments of the invention, when the results from both the multiple vector ALU 470 and the add vector ALU 480 are written to the same accumulator or I/O location, the behavior may be considered undefined.

In order to be robust and achieve, for example power efficiency in the QPU 400 pipeline, register-file locations written in one instruction need not be read back in the following instruction. Since such behavior may be undefined, a programmer may want to ensure that such behavior does not occur. Programs that are associated with the operation of the QPU 400 may be encouraged to maximize the use of the accumulators in the accumulators 460 whenever such use is possible. The accumulators 460 may be lower power devices than the register-files A and B, and may be used in the following instruction immediately after being written to.

The instruction encoding associated with the QPU 400 may comprise two sets of condition fields, one each for the results from the multiply vector ALU 470 and the add vector ALU 480, for example. These sets of condition fields may allow independent conditional writing out of the result from either the multiply vector ALU 470 and the add vector ALU 480 based on the current condition flags. In one embodiment of the invention, the setting of the condition flags for an instruction may be optional and may apply to the conditional behavior of the same instruction.

When the QPU 400 is operable such that 32-bit data may be supplied by a Load Immediate instruction, for example, the data need not be used directly as an ALU input argument, and may instead be replicated 16-ways and written to an accumulator or register in place of the ALU results. In such instances, the QPU 400 may not provide support for supplying immediate values within normal ALU instructions.

Branches that occur in the QPU 400 may be conditional. When the QPU 400 may comprise a SIMD array with 16 elements, for example, the branches may be based on the status of the ALU flag bits across the elements of the SIMD array. For simplicity, the QPU 400 may be operable such that branch prediction need not be used and sequentially fetched instructions need not be canceled when a branch is encountered. In this regard, three (3) delay slot instructions following a branch instruction may be typically executed. On branch instructions the ‘link’ address of the current instruction, such as the program counter (PC) in FIG. 4, for example, plus 3 may be present in place of the add vector ALU 480 result value and may be written to a register to support branch-with-link functionality, for example.

The instructions to the ALUs in the QPU 400 may include a signaling field, which allows a variety of actions to be signified without costing an additional instruction. Most of the uses of the signaling field may be for efficient interfacing to the tile buffer, such as the TLB 318 described above with respect to FIG. 3, for example. Signaling codes may also used to indicate the end of a program or a thread switch, which in both cases may occur after a further two delay slot instructions, for example.

When the QPU 400 is executing a threadable program, local thread storage may be provided by dividing each of the register-files A and B into two, with 16 locations for each of the two threads, for example. The addresses of the two halves of the register-file may be swapped when executing the second thread. Some of the register-space mapped I/O locations for interfacing with the 3D pipeline may also be swapped for the second thread. Because the accumulators may not be duplicated for the second thread, threadable programs may need to use register-files to maintain data across thread switches. Thread switching may be entirely cooperative via ‘thread switch’ signaling instructions.

Programs executed in connection with the QPU 400 may be started by a centralized QPU scheduler unit such as the QSH 314 described above with respect to FIG. 3. The QPU scheduler may receive automatic requests from the 3D pipeline to run shader processing programs. Shader programs may be specified by shader state records in a control list, giving an initial program counter (PC) and a uniforms cache (see QUC 344 in FIG. 3) base address and size. Requests to run general-purpose programs may also be sent to the QPU scheduler by a queue written via system registers, for example, such as to supply the initial PC address and optional uniforms base address for the programs.

QPU programs may be terminated by an instruction including a program end signal. Two delay-slot instructions may be executed after the program end instruction before the QPU 400 becomes idle. Once a program has terminated, the QPU 400 may be immediately available to the QPU scheduler for a new program, which may be started back-to-back on the next instruction cycle.

The QPU 400 may be operable to execute core instructions within four (4) system clocks, for example, but may stall to wait for certain I/O operations to complete. Examples of operations that the QPU 400 may stall for comprise instruction cache miss, register-space input not ready such as special function result, uniform read, texture lookup result, varyings read, vertex and primitive memory read, vertex cache manager and DMA completion, for example. The QPU 400 may also stall for register space output not ready such as special function request, texture lookup request, vertex and primitive memory write, for example, and for scoreboard lock/unlock signaling, tile buffer load signaling, and tile buffer writes, for example.

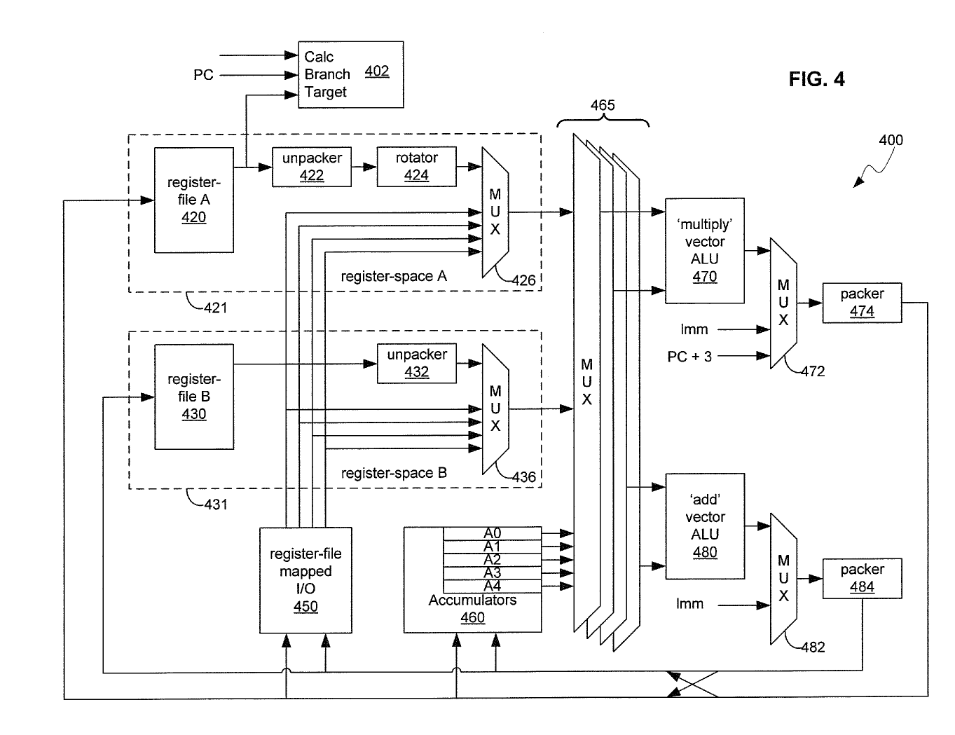

FIG. 5 is a block diagram that illustrates a typical connection between a CPU and devices external to the CPU, in connection with an embodiment of the invention. Referring to FIG. 5, there is shown a CPU 500 that comprises a first ALU 502, a second ALU 504, and a register file 506. Also shown are an SDRAM 520 and peripherals 530, both of which are operably coupled to the CPU 500 via a memory bus 540. The memory bus 540 may be an I/O bus, for example.

The first ALU 502 and the second ALU 504 may each comprise suitable logic, circuitry, and/or interfaces that may be operable to perform integer and floating point multiply, integer add, other multiply-type operations, add-type operations, integer bit manipulations, shifts, and/or logical operations. The register file 506 may comprise suitable logic, circuitry, and/or interfaces that may be operable to store bits of information.

The SDRAM 520 may comprise suitable logic, circuitry, and/or interfaces that may be operable to store data and/or instructions associated with the operation of the CPU 500. The peripherals 530 may comprise suitable logic, circuitry, code, and/or interfaces that may be operable to perform operations associated with the CPU 500.

In operation, the ALUs 502 and 504 may read and/or write data and/or instructions from the register file 506 in the CPU 500. Data and/or instructions may be written to and/or read from the SDRAM 520 and/or the peripherals 530 by the CPU 500 via the memory bus 540. Access to the SDRAM 520 and/or the peripherals 530 via the memory bus 540 may be performed by memory mapping such devices, that is, by using a memory mapped I/O approach. Access to the SDRAM 520 and/or the peripherals 530 via the memory bus 540, however, may not be fast enough in some applications, such as for 3D video and/or gaming applications, for example.

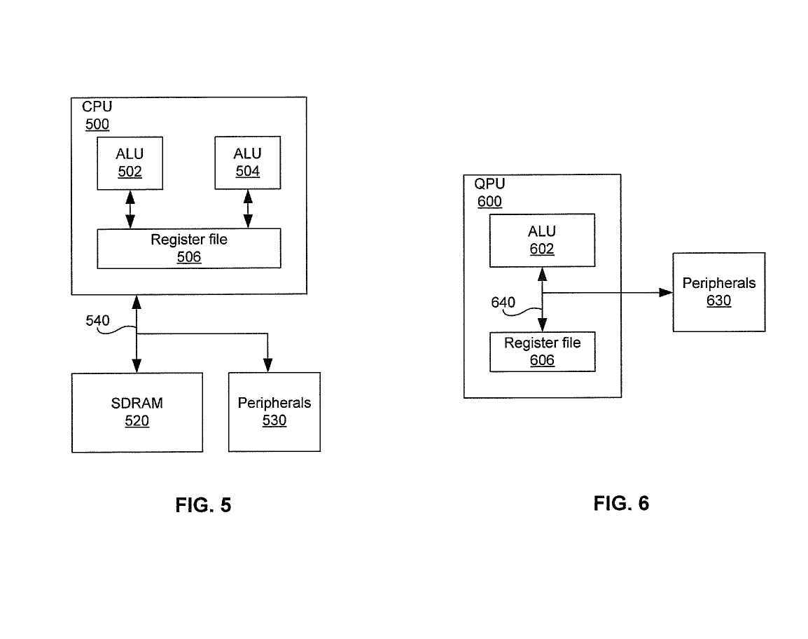

FIG. 6 is a block diagram that illustrates a peripheral device operably coupled to a shader processor via a register file bus, in accordance with an embodiment of the invention. Referring to FIG. 6, there is shown a QPU 600 that may comprise an ALU 602 and a register file 606. The QPU 600 may correspond to, for example, one or more of the QPUs 350, 352, 354, and 356 shown in FIG. 3, and the QPU 400 shown in FIG. 4. The QPU 600 may be utilized as a shader processor or may correspond to a portion of a shader processor. The ALU 602 may correspond to, for example, one or more of the multiply vector ALU 470 and the add vector ALU 480 shown in FIG. 4. The register file 606 may correspond to, for example, one or both of the register-files A and B shown in FIG. 4. The ALU 602 and the register file 606 may communicate via a register file bus 640.

Also shown in FIG. 6 are peripherals 630. The peripherals 630 may comprise suitable logic, circuitry, code, and/or interfaces that may be operable to perform operations associated with the QPU 600. The operations performed by the peripherals 630 may have a fixed latency or a variable latency. The peripherals 630 may communicate with one or both of the ALU 602 and the register file 606 via the register file bus 640. The register file bus 640 may comprise suitable logic, circuitry, and/or interfaces that may be operable to allow reading and/or writing of data and/or instructions. The peripherals 630 may comprise a single peripheral device or a plurality of peripheral devices.

In one embodiment of the invention, the QPU 600 may be a 4-way SIMD processor operable to perform four (4) multiply and four (4) add operations per cycle. Each SIMD channel in the QPU 600 may utilize a pair of 3-stage floating-point execute pipelines without the need for stall or interlocks. The stalls may be localized at the register-fetch stage at the start of the pipeline, for example.

The peripherals 630 may correspond to one or more of texture units, varying interpolators, color and depth tile memories, vertex and primitive memories, and other like components. For example, the peripherals 630 may correspond to one or more components or processing blocks in the 3D pipeline 300 described above with respect to FIG. 3.

The peripherals 630 may be closely coupled to the QPU 600. That is, the inputs and/or outputs of the peripherals 630 may be mapped to a register space in the QPU 600 and may be written to and read by an instruction executed in the QPU 600.

In one embodiment of the invention, the QPU 600 may comprise one or more 32-entry register files, such as register-files A and B, for example. When the 32-entry register file is written to or read from utilizing 6-bit addresses, there may be up 64 register addresses that may be accessed. A peripheral device may be mapped to or be associated with any one of the 32 register addresses that are not backed by a physical register. For example, the 64 register addresses may comprise register addresses ra0-ra31 and rb0-rb31, where register addresses ra0-ra31 may correspond to the 32 physical registers in the register file and rb0-rb31 may be mapped to or associated with one or more peripheral devices, such as the peripherals 630, for example.

In operation, the ALU 602 may read and/or write data and/or instructions from the register file 606 in the QPU 600 and/or from the peripherals 630 via the register file bus 640. Access to the register file 606 may occur by using register addresses that correspond to the physical registers in the register file 606. Access to the peripherals 630 may occur by using register addresses that do not correspond to physical registers but are instead mapped to or associated with the peripherals 630. Having the peripherals 630 closely coupled to the QPU 600 may allow 3D video and/or gaming applications, for example, to be more effectively implemented.

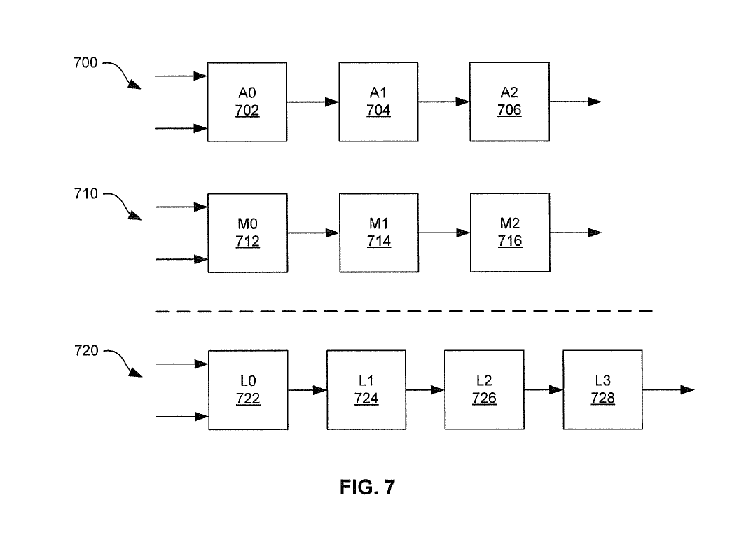

FIG. 7 is a block diagram that illustrates shader processor pipelines and a peripheral pipeline, in accordance with an embodiment of the invention. Referring to FIG. 7, there is shown a 3-cycle pipeline structure 700 that comprises cycles A0 (702), A1 (704), and A2 (706), and a 3-cycle pipeline structure 710 that comprises cycles M0 (712), M1 (714), and M2 (716). The 3-cycle pipeline structure 700 may be associated with addition operations that may be performed by a QPU such as the QPU 400, for example. The 3-cycle pipeline structure 720 may be associated with the multiplication operations that may be performed by a QPU such as the QPU 400, for example. The dual-pipeline illustrated in FIG. 7 may be nicely balanced such that each pipeline may take about the same amount of time to be performed.

Devices that are peripheral to the QPU, such as the peripherals 630 described above, may be utilized to, for example, perform certain operations that do not fit in the fixed-cycle pipeline of the QPU. For example, certain floating point operations, such as base-2 logarithm, are hard to fit into a 3-cycle pipeline structure without impacting timing. A base-2 logarithm structure is illustrated in FIG. 7 with a 4-cycle pipeline structure 720 that comprises cycles L0 (722), L1 (724), L2 (726), and L3 (728). Implementing these operations in a peripheral may allow the use of a more deeply pipelined implementation without affecting the QPU pipeline structure. Other operations, such as those with non-deterministic latency may also be challenging to implement. An example of an operation with non-deterministic latency is a memory access operation.

In some embodiments of the invention, the performance of the peripheral may be additive to the core QPU performance as non-dependent add and multiply operations may occur while waiting for results from the peripheral device. For example, writing to a register r36 that is mapped to or associated with a peripheral device to start a base-2 logarithm operation, and subsequently reading from the same register r36 to retrieve the result may be illustrated with the following set of exemplary instructions:

fadd r36, r0, r1; trigger flog2(r0+r1)

fmul r2, r3, r36; compute r2=r3*flog2(r0+r1).

By using a peripheral device, at no point does a logarithm instruction appear in the stream and no instruction bandwidth will need to be utilized.

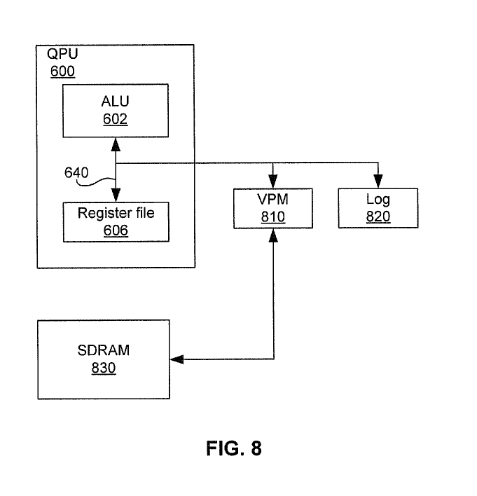

FIG. 8 is a block diagram that illustrates different peripheral devices operably coupled to a shader processor via a register file bus, in accordance with an embodiment of the invention. Referring to FIG. 8, there is shown the QPU 600 that comprises the ALU 602 and the register file 606. Also shown as peripherals operably coupled to the QPU 600 via the register file bus 640 are a VPM 810 and a log block 820. The VPM 810 may correspond to, for example, the VPM 316 described above with respect to FIG. 3. The log block 820 may comprise suitable logic, circuitry, code, and/or interfaces that may be operable to perform a logarithm operation such as the 4-cycle base-2 logarithm operation described above with respect to FIG. 7. Coupled to the VPM 810 may be a SDRAM 830 that may be accessed as a peripheral device by the QPU 600 via the VPM 810.

In the embodiment of the invention illustrated in FIG. 8, the log block 820 may correspond to a peripheral operation having a known or fixed latency, while accessing the SDRAM 830 via the VPM 810 may correspond to a peripheral operation having a variable latency. Variable latency operations may occur because of a memory subsystem access or because the peripheral being accessed to perform an operation is shared with other QPUs, for example. Variable latency operations may be hard to accommodate in a conventional pipeline without affecting performance, such as by waiting synchronously for the operation to complete, for example, or introducing complex interlocks, such as allowing the operation to complete asynchronously and blocking at first use, for example. The architecture and/or operation of the QPU, however, may allow the execution of other instructions after the register write that initiates the peripheral operation, thereby hiding latency. The instruction that reads the result may be easily stalled at the start of the pipeline with an interlock if the operation is yet to complete.

In addition to giving consideration to the latency of an operation, there may be certain arithmetic operations that may be used much less often than addition and multiplication operations. If the logic required for implementing such arithmetic operations were to be placed directly in the main pipeline of a QPU, such logic would likely be frequently idle. By placing it in a peripheral device instead, it may be made narrower than the main data path. For example, a scalar implementation that computes the results for the SIMD channels in four (4) cycles may be utilized. A similar result may be achieved by having the peripheral device that performs the arithmetic operation be shared by more than one QPU.

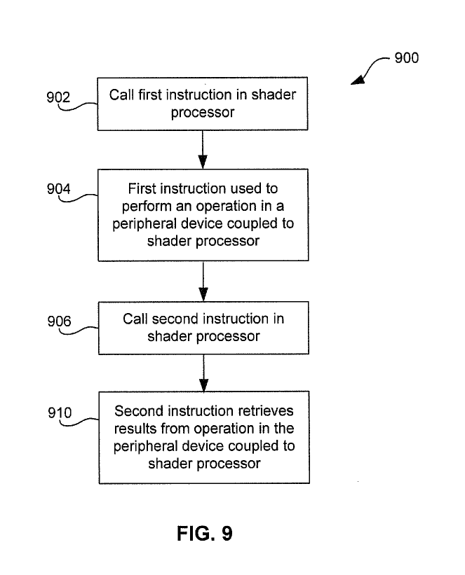

FIG. 9 is a flow diagram that illustrates exemplary steps for performing an operation in a peripheral device operably coupled to a shader processor, in accordance with an embodiment of the invention. Referring to FIG. 9, there is shown a flow diagram 900. At step 902, a first instruction may be called in a shader processor. The shader processor may be a QPU such as the QPU 400 described above with respect to FIG. 4. The first instruction may be an instruction that may be performed by the shader processor without affecting the timing of the shader processor. At step 904, calling the first instruction in the shader processor may result in an operation being performed in a peripheral device operably coupled to the shader processor via a register file bus in the shader processor. The operation in the peripheral device may have a fixed or a variable latency, for example. The operation in the peripheral device may be an operation that is infrequently performed in association with the shader processor, for example.

At step 906, a second instruction may be called in the shader processor. The second instruction may be an instruction that may be performed by the shader processor without affecting the timing of the shader processor. At step 910, calling the second instruction may result in retrieving results from the operation in the peripheral device operably coupled to the shader processor.

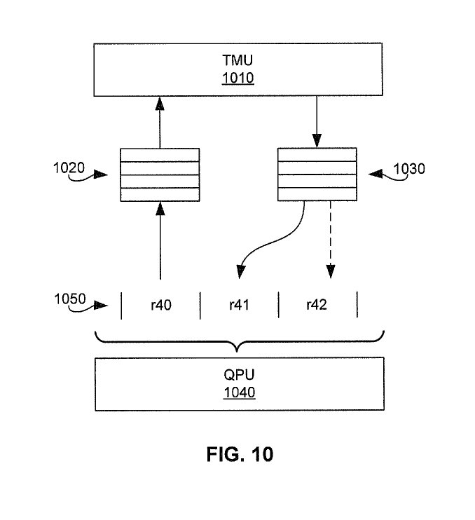

FIG. 10 is a block diagram that illustrates an example of operably coupling a shader processor and a peripheral device utilizing a FIFO, in accordance with an embodiment of the invention. Referring to FIG. 10, there is shown a TMU 1010, a first FIFO 1020, a second FIFO 1030, and a QPU 1040.

The TMU 1010 may correspond to, for example, the texture and memory lookup unit (TMU) 348 described above with respect to FIG. 3. The QPU 1040 may correspond to, for example, the QPU 400 described above with respect to FIG. 4. The first FIFO 1020 and the second FIFO 1030 may each comprise suitable logic, circuitry, code, and/or interfaces that may be operable to receive and transfer data and/or instructions between two or more devices such as the TMU 1010 and the QPU 1040, for example.

In the example illustrated in FIG. 10, the first FIFO 1020 may comprise an input that is mapped to or associated with a register address r40. The register address r40 may correspond to a register address accessible via a register file bus in the QPU 1040 that is not backed by a physical register, for example. The first FIFO 1020 may comprise an output that is coupled to the TMU 1010 such that data and/or instructions provided via the register address r40 may be transferred or communicated to the TMU 1010. In this regard, the register address r40 may take texture coordinates (s, t) from the QPU 1040 to be communicated to the TMU 1010.

The second FIFO 1030 may comprise an output that is mapped to or associated with one or more register addresses. In this example, the output may be mapped to register addresses r41 and r42. The register address r41 and r42 may correspond to register addresses accessible via a register file bus in the QPU 1040 that are not backed by a physical register, for example. Mapping the output of the second FIFO 1030 to two different locations in the register space may allow one location to read the value, that is, peek, while the other location reads the value and advances the read pointer, that is, pop. The first FIFO 1020 may comprise an input that is coupled to the TMU 1010 such that data and/or instructions provided from the TMU 1010 may be transferred or communicated to the QPU 1040. In this regard, the register addresses r41 and r42 may both return result components (r, g, b, a) in sequence, with the register address r42 effecting a pop.

In operation, a write to register r40 called in the QPU 1040 may push values, such as texture coordinates, for example, into the first FIFO 1020, which in turn communicates those values to the TMU 1010. A read called in the QPU 1040 may take values from the second FIFO 1030, such as result components, for example, communicated to the second FIFO 1030 from the TMU 1010. When a read is made to register r41 the values from the second FIFO 1030 may be read in sequence. When a read is made to register r42, the values from the second FIFO 1030 may be read in sequence and a pop may be effected.

Below is an example instruction set that sequentially writes values to and reads values from the TMU 1010:

fadd r40, r0, r1; submit s=r0+r1

fadd r40, r2, r3; submit t=r2+r3, and trigger TMU 1010

fmul r4, r5, r41; compute r4=r5*r

fmul r6, r7, r42 compute r6=r7*r, and pop

fmul r8, r9, r41 compute r8=r9*g.

While the embodiment illustrated in FIG. 10 shows a texture and memory lookup unit being operably coupled to a QPU using one or more FIFOs, other embodiments need not be so limited. For example, other components or processing blocks of a 3D pipeline, such as the 3D pipeline 300, for example, may also be operably coupled to a QPU using one or more FIFOs.

There may be instances when a peripheral device is coupled to a shader processor or QPU without the use of a FIFO. For example, when the area overhead of providing a full-blown FIFO is too great, a single register that receives the result of the peripheral may be utilized. Such an approach may be suitable in instances in which the peripheral device has a predictable latency and there is at any one point in time a single outstanding value. Another use of this approach may be to read from a peripheral that produces a stream of values without requiring an input. In such a case, a signaling field embedded in each instruction may be utilized to advance the read position in the stream without the need to utilize an instruction.

In some embodiments of the invention, the coordinate shader and/or the vertex shader may be compiled to be programmed into processors such as digital signal processors (DSPs), for example, and/or programmable hardware devices, for example. In other embodiments of the invention, the coordinate shader and/or the vertex shader may be compiled from source code described using a hardware-based programming language such that the compilation may be utilized to generate or configure an integrated circuit such as an application specific integrated circuit (ASIC) and/or a programmable device such as a field programmable gate array (FPGA), for example.

In an embodiment of the invention, a shader processor, such the QPU 600 in FIGS. 6 and 8, for example, may be operable to execute a first instruction associated with a graphics rendering operation. The shader processor may be operably coupled to a peripheral device, such as peripherals 630, for example, via the register file bus 640 in the QPU 600. The peripherals 630 may be operable to perform an operation associated with the graphics rendering operation in response to the execution of the first instruction in the QPU 600. The QPU 600 may receive result information from an intermediate portion of the graphics rendering operation performed by the peripherals 630. The register file bus 640 may be utilized for handling execution of intermediate instructions comprising the performed operation. The QPU 600 may be operable to execute a second instruction associated with the graphics rendering operation based on the result information received from the peripherals 630.

Moreover, the QPU 600 may be operable to access the peripherals 630 via one or more register file addresses associated with the peripherals 630. The operation performed in the peripherals 630 may comprise an operation based on a base-2 logarithm. The operation performed in the peripherals 630 may comprise a variable latency operation. The peripherals 630 may be operably coupled to the QPU 600 via a FIFO comprising an input associated with a register file address in the QPU 600. An example of such a FIFO is the FIFO 1020 described above with respect to FIG. 10, which is coupled to the QPU 1040. The peripherals 630 may be operably coupled to the QPU 600 via a FIFO comprising an output associated with one or more register file addresses in the QPU 600. An example of such a FIFO is the FIFO 1030 described above with respect to FIG. 10, which is coupled to the QPU 1040. The QPU 600 may be operable to execute, between the first instruction and the second instruction, one or more intermediate instructions associated with the graphics rendering operation that are independent from the result information associated with said intermediate portion of the graphics rendering operation performed in the peripherals 630.

The QPU 600 may comprise a fixed-cycle-pipeline architecture. The QPU 600 may comprise a SIMD architecture. The peripherals 630 may comprise one or more of a texture unit, a varying interpolator, a color tile memory, a depth tile memory, a vertex memory, and a primitive memory, such as those described above with respect to FIG. 3.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for a shader processor with closely-coupled peripherals.

Accordingly, the present invention may be realized in hardware, software, or a combination of hardware and software. The present invention may be realized in a centralized fashion in at least one computer system or in a distributed fashion where different elements may be spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for graphics processing, comprising:
executing a first instruction associated with a graphics rendering operation in a shader processor;
receiving result information associated with an intermediate portion of said graphics rendering operation, said intermediate portion of said graphics rendering operation performed by a peripheral device operably coupled to a register file bus in said shader processor, wherein said register file bus is utilized for handling execution of intermediate instructions associated with said intermediate portion of said graphics rendering operation; and
executing a second instruction associated with said graphics rendering operation in said shader processor based on said received result information.

2. The method according to claim 1, comprising accessing said peripheral device via one or more register file addresses associated with said peripheral device.

3. The method according to claim 1, wherein said operation performed in said peripheral device comprises an operation based on a base-2 logarithm.

4. The method according to claim 1, wherein said operation performed in said peripheral device comprises a variable latency operation.

5. The method according to claim 1, wherein said peripheral device is operably coupled to said shader processor via a FIFO comprising an input associated with a register file address in said shader processor.

6. The method according to claim 1, wherein said peripheral device is operably coupled to said shader processor via a FIFO comprising an output associated with one or more register file addresses in said shader processor.

7. The method according to claim 1, comprising executing, between said first instruction and said second instruction, one or more intermediate instructions associated with said graphics rendering operation in said shader processor that are independent from said result information associated with said intermediate portion of said graphics rendering operation.

8. The method according to claim 1, wherein said shader processor comprises a fixed-cycle-pipeline architecture.

9. The method according to claim 1, wherein said shader processor comprises a single-instruction-multiple-data (SIMD) architecture.

10. The method according to claim 1, wherein said peripheral device comprises one or more of a texture unit, a varying interpolator, a color tile memory, a depth tile memory, a vertex memory, and a primitive memory.

11. A system for graphics processing, comprising:
a shader processor operable to execute a first instruction associated with a graphics rendering operation;
said shader processor being operable to receive result information associated with an intermediate portion of said graphics rendering operation, said intermediate portion of said graphics rendering operation performed by a peripheral device operably coupled to a register file bus in said shader processor, wherein said register file bus is utilized for handling execution of intermediate instructions associated with said intermediate portion of said graphics rendering operation; and
said shader processor being operable to execute a second instruction associated with said graphics rendering operation based on said received result information.

12. The system according to claim 11, wherein said shader processor is operable to access said peripheral device via one or more register file addresses associated with said peripheral device.

13. The system according to claim 11, wherein said operation performed in said peripheral device comprises an operation based on a base-2 logarithm.

14. The system according to claim 11, wherein said operation performed in said peripheral device comprises a variable latency operation.

15. The system according to claim 11, wherein said peripheral device is operably coupled to said shader processor via a FIFO comprising an input associated with a register file address in said shader processor.

16. The system according to claim 11, wherein said peripheral device is operably coupled to said shader processor via a FIFO comprising an output associated with one or more register file addresses in said shader processor.

17. The system according to claim 11, wherein said shader processor is operable to execute, between said first instruction and said second instruction, one or more intermediate instructions associated with said graphics rendering operation that are independent from said result information associated with said intermediate portion of said graphics rendering operation.

18. The system according to claim 11, wherein said shader processor comprises a fixed-cycle-pipeline architecture.

19. The system according to claim 11, wherein said shader processor comprises a single-instruction-multiple-data (SIMD) architecture.

20. The system according to claim 11, wherein said peripheral device comprises one or more of a texture unit, a varying interpolator, a color tile memory, a depth tile memory, a vertex memory, and a primitive memory.
